(19) United States
(12) Patent Application Publication
(10) Pub. No.: US 2023/0324055 A1
(43) Pub. Date: Oct. 12, 2023

(54) COLLAPSIBLE AIR HUMIDIFIER

(71) Applicant: SHENZHEN HEBRON TECHNOLOGY CO., LTD, Shenzhen City (CN)

(72) Inventor: AI LI, SHENZHEN CITY (CN)

(21) Appl. No.: 17/742,519

(22) Filed: May 12, 2022

(30) Foreign Application Priority Data
Apr. 7, 2022 (CN) 202220800677.3

(51) Int. Cl. F24F 6/14; F24F 11/89

(52) U.S. Cl. CPC F24F 6/14; F24F 11/89; F24F 2006/008

(57) ABSTRACT

Disclosed is a collapsible air humidifier, comprising: a base including a containing cavity having an upper open; and a water tank that is collapsible having a bottom cover, a lower section, a middle section, an upper section and a top cover, wherein the lower section is mounted on the containing cavity, the middle section and the upper section are mounted above the containing cavity, and the upper section and the middle section are stored within the middle section when the water tank is in a collapsed state; and wherein the lower section and the upper section are rigid pieces, the middle section is a flexible piece, an upper end of the middle section is connected to and sealed with a lower end of the upper section, and a lower end of the middle section is connected to and sealed with an upper end of the lower section.

### FIELD OF THE DISCLOSURE

The present disclosure relates to the technical field of air humidifiers, in particular, to a collapsible air humidifier.

### BACKGROUND OF THE DISCLOSURE

The traditional air humidifier has a large volume due to its own water tank, and occupies a large space during storage and transportation, so there are disadvantages of poor convenience and high cost.

For solving the problem, people have developed collapsible air humidifiers, such as a kind of folding humidifier disclosed in the document CN110425676A. When this type of humidifier is not in use, the water tank can be collapsed, which greatly reduces the space occupied by the air humidifier, makes storage and transportation more convenient, and reduces storage and transportation costs.

The water tank of the above-mentioned collapsible humidifier is composed of a top cover, a top cover pressing plate, a bottom cover, a bottom cover pressing plate and a collapsible part. The collapsible part specifically comprises a collapsible side surface and a second sealing ring located at the lower part of the collapsible side surface, and the collapsible side surface has at least a first collapsible place and a second collapsible place from top to bottom. The top cover and the top cover pressing plate are arranged above the first collapsible place and fixed by clamping the collapsible part, and the bottom cover and the bottom cover pressing plate are arranged below the second collapsible place and fixed by clamping the second sealing ring. On the one hand, since the bottom cover clamps the collapsible part with the bottom cover through the bottom cover pressing plate, and is connected with the collapsible part, water leakage failure easily occurs at the clamping place, so the reliability of the humidifier will be affected. On the other hand, since the main structure of the water tank is composed of collapsible parts, when the water tank is empty and in the collapsed state, the strength of the side of the water tank is not enough to support the top cover of the humidifier. Therefore, in this document, the bottom cover pressing plate is extended to the second collapsible place, the top cover pressing plate is extended to the first collapsible place, and the strength of the two sides of the collapsible part is increased. In this way, although the problem of insufficient side strength is solved after the water tank is collapsed, the top cover pressing plate and the bottom cover pressing plate are not strong enough. The structure becomes complicated, which is not conducive to the assembly of the bottom cover and the top cover with the collapsible parts when constructing the water tank. Besides, in addition to the top cover, bottom cover and collapsible parts, the water tank further includes a top cover pressing plate and a bottom cover pressing plate, so the structure is complicated, and the material cost and production cost are high.

### SUMMARY OF THE DISCLOSURE

The purpose of the present disclosure is to provide a collapsible air humidifier to solve the above-mentioned defects of the related art at least to a certain extent.

For reaching the above object, the technical solution adopted in the present disclosure is as follows.

A collapsible air humidifier is provided, comprising: a base including a containing cavity having an upper open; and a water tank that is collapsible having a bottom cover, a lower section, a middle section, an upper section and a top cover, wherein the lower section is mounted on the containing cavity, the middle section and the upper section are mounted above the containing cavity, and the upper section and the middle section are stored within the middle section when the water tank is in a collapsed state; and wherein the lower section and the upper section are rigid pieces, the middle section is a flexible piece, an upper end of the middle section is connected to and sealed with a lower end of the upper section, and a lower end of the middle section is connected to and sealed with an upper end of the lower section.

Preferably, each of a connection between the middle section and the upper section and a connection between the middle section and the lower section is formed by a bonding process, a soldering process or a welding process.

Preferably, an edge of the top cover is higher than a center of the top cover, so that a water collecting pool is formed at a top of the water tank, and a bottom of the water collecting pool is provided with at least one through hole that communicates with an inside of the water tank.

Preferably, multiple ones of the through holes are provided, each of the through holes is distributed on a circumference with a center of the top cover as a center of a circle, a top of the top cover is provided with a small cover at the center, and the small cover includes an inverted conical cover bottom extending upward and outward gradually from the center of the top cover, a gap is formed between the inverted conical cover bottom and the top cover, the gap communicates with each of the through holes, and a projection of the small cover on a top plate covers each of the through holes.

Preferably, the small cover is a hollow structure.

Preferably, the bottom cover of the water tank is provided with a pump and a first electrical connector, a water inlet of the pump is communicated with the water tank, a water outlet of the pump is connected with a jet atomizer, the top cover of the water tank is provided with a mist outlet, a pipe is connected between the mist outlet and the jet atomizer in the water tank, the pipe is retractable or bendable, and the base is provided with a second electrical connector at a position corresponding to a first electrical connector.

Preferably, the bottom cover of the water tank is provided with a water valve and a mist inlet, a bottom of the containing cavity is provided with an ultrasonic atomizer, an atomizing cavity communicating with the water valve and the mist inlet is formed between the bottom cover of the water tank and the bottom of the containing cavity, the top cover of the water tank is provided with a mist outlet, a pipe is connected between the mist outlet and the mist inlet in the water tank, and the pipe is retractable or bendable.

Preferably, the base is further provided with a fan, and an air outlet of the fan communicates with the pipe.

Preferably, the top cover of the water tank is provided with a pipe joint, the pipe is arranged in the water tank, one end of the pipe is connected to the pipe joint, another end of the pipe is connected to a mist outlet end of a jet atomizer or to a atomizing cavity, and the pipe is retractable or bendable.

Preferably, a man-machine interface is provided on an outer part of the base, and the man-machine interface is electrically connected to a controller of the collapsible air humidifier.

Preferably, the bottom cover is integrally formed with the lower section.

Compared with the prior art, the present disclosure at least has the following beneficial effects.

The rigid upper and lower sections and the flexible middle section are combined to replace the collapsible parts of the existing collapsible water tank, not only the collapsible of the water tank can be embodied, but also the side of the water tank has sufficient strength when the water tank is collapsed and vacant, so it is no longer necessary to strengthen the side portion of the water tank with the top cover pressing plate and the bottom cover pressing plate, and the structure of the water tank is simplified.

Compared with the existing water tank connection structure in which the collapsible parts are clamped by two plates, the upper, middle and lower sections of the water tank are connected by bonding, welding or welding, which has the advantages of convenient manufacture and less water leakage failure.

### BRIEF DESCRIPTION OF THE DRAWINGS

FIG. 1 is a schematic structural diagram of a collapsible air humidifier according to a first embodiment.

FIG. 2 is a schematic structural diagram of a base of the collapsible air humidifier.

FIG. 3 is an exploded view of a water tank of the collapsible air humidifier.

FIG. 4 is a schematic diagram of the internal structure of the collapsible air humidifier according to the first embodiment.

FIG. 5 is the enlarged view of A part in FIG. 4.

FIG. 6 is a schematic structural diagram of a top cover of the water tank.

FIG. 7 is a schematic structural diagram of a humidifier according to a second embodiment.

FIG. 8 is a schematic diagram of the internal structure of the collapsible air humidifier according to the second embodiment.

Reference numeral: 100: base; 101: man-machine interface; 102: containing cavity; 103: ultrasonic atomizer; 104: steps; 105: fan; 200: water tank; 201: top cover; 202: water collecting pool; 203: small cover; 2031: inverted conical cover bottom; 2032: gap; 204: mist outlet; 205: through hole; 206: upper section; 207: middle section; 208: lower section; 209: mist inlet; 210: water valve; 211: bottom cover; 212: pipe joint; 213: pump; 300: atomizing cavity; 400: pipe.

### DETAILED DESCRIPTION OF THE EXEMPLARY EMBODIMENTS

The present disclosure will be further described below with reference to the accompanying drawings and embodiments.

### First Embodiment

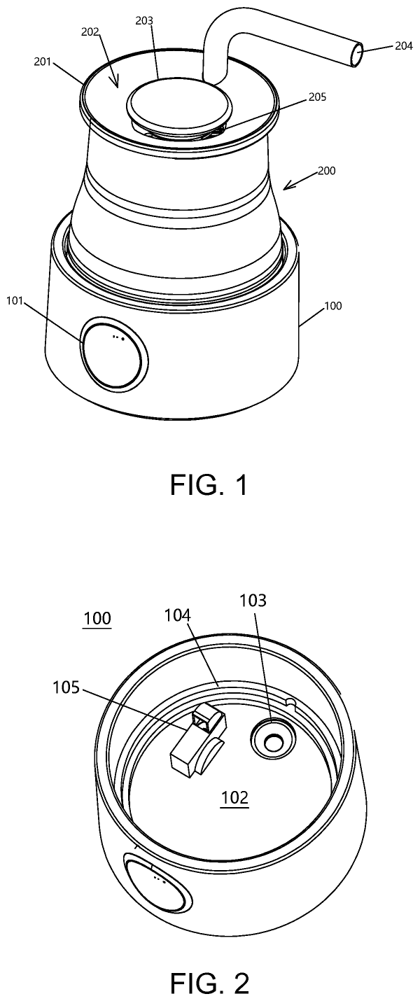

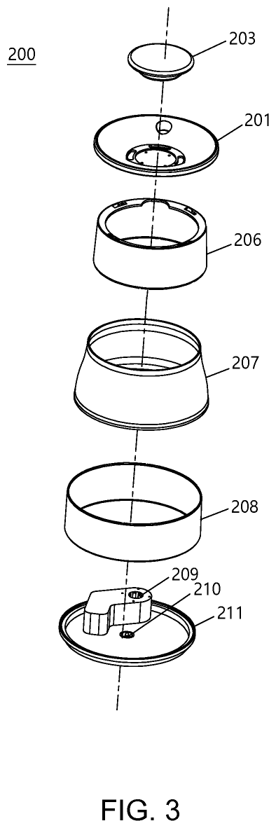

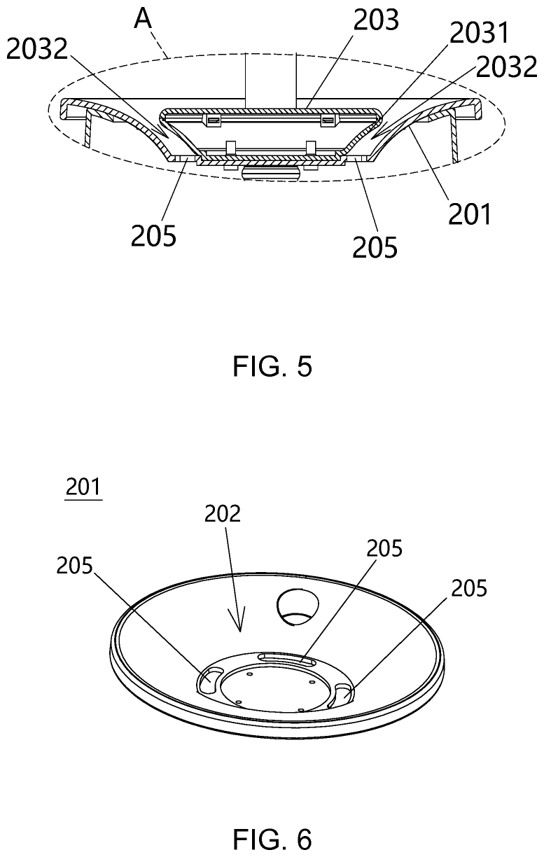

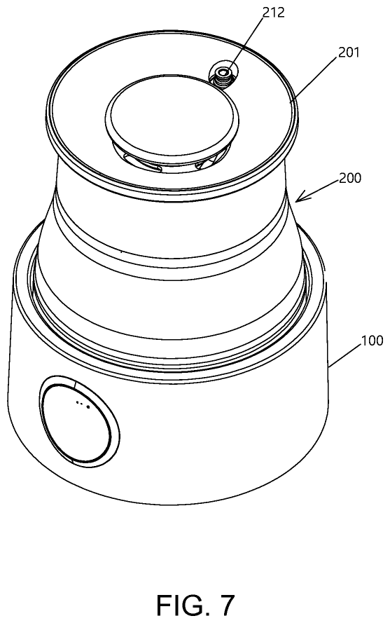

Reference is made to FIGS. 1 to 6. The air humidifier is a collapsible air humidifier, which includes a base 100 and a water tank 200. The base 100 is provided with a containing cavity 102 having an upper opening, and the water tank 200 has a bottom cover 211, a lower section 208, a middle section 207, an upper section 206 and a top cover 201.

The middle section 207 of the water tank 200 is a flexible member. For example, it can be made of glue, soft rubber, etc., and can be bent and deformed.

Both the lower section 208 and the upper section 206 of the water tank 200 are rigid members. For example, they can be made of hard plastic, metal, or the like.

The upper end of the middle section 207 is bonded with the lower end of the upper section 206, and the lower end of the middle section 207 is bonded with the upper end of the lower section 208. Preferably, a slot is provided at one of the connection ends, a tongue is provided at the other corresponding connection end, glue is applied to the tongue and its surroundings, and then the tongue is inserted into the slot to bond the two together, which increases the bonding surface and achieves a stronger bond. As another embodiment, the middle section 207, the upper section 206 and the lower section 208 are all made of materials with close melting points, and the middle section 207 and the upper section 206 and the middle section 207 and the lower section 208 are connected by a heating and welding process, or an ultrasonic welding process is used to connect them. The present disclosure is not limited by this, and any manner capable of embodying the end joint sealing can be used.

The lower end of the lower section 208 is bonded to the bottom cover 211, and similarly, welding and welding processes may be used to connect them. In addition, the bottom cover 211 and the lower section 208 can also be integrally formed, so that the bottom cover 211 and the lower section 208 do not need to be connected and the manufacturing process is shorter, and water leakage between the bottom cover 211 and the lower section 208 can be avoided.

The top of the upper section 206 is provided with an inner collapsed edge, a button hole is arranged on the inner collapsed edge, and a buckle is arranged at the bottom of the top cover 201. The top cover 201 is installed on the top of the upper section 206 through the cooperation of the buckle and the buckle hole. The present disclosure is not limited to this connection method. For example, the top cover 201 and the upper section 206 can also be connected by bonding, soldering, welding and other processes, or the top cover and the upper section can be integrally formed.

The bottom cover 211, the lower section 208, the middle section 207, the upper section 206 and the top cover 201 form a water tank that is collapsible 200. When the top cover 201 is pressed down, the middle section 207 is bent and deformed, so that the middle section 207 and the upper section 206 enter the lower section 208. Therefore, the water tank 200 can be collapsed. In the collapsed state, the height of the water tank 200 is only about one third of the height in the uncollapsed state.

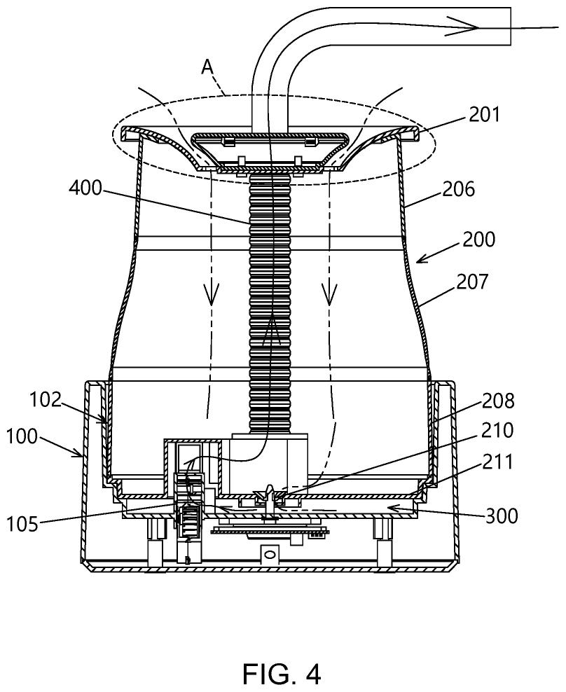

The lower section 208 of the water tank 200 is installed in the containing cavity 102 of the base 100. As shown in FIG. 1 and FIG. 4, when the water tank 200 is uncollapsed, the lower section 208 is installed in the containing cavity 102, and the middle section 207 and the upper section 206 are mounted above the containing cavity 102.

After the water tank 200 is changed to the collapsed state, the upper section 206 and the middle section 207 are stored in the lower section 208. The top cover 201 of the water tank 200 is generally positioned at the mouth of the containing cavity 102 of the base 100, so that the overall height of the collapsible air humidifier is reduced by about two-thirds, and only a small storage space is required to store the collapsible air humidifier.

It can be seen from the above that by adopting the rigid upper section 206 and the lower section 208 and the flexible middle section 207, the upper end of the middle section 207 is bonded to the lower end of the upper section 206, and the lower end of the middle section 207 is bonded to the upper end of the lower section 208, which can replace the collapsible part of the existing collapsible water tank, so that it is unnecessary to configure the upper cover pressing plate and the lower cover pressing plate, and is not necessary to extend the upper cover pressing plate and the lower cover pressing plate to the first collapsible place and the second collapsible place of the collapsible part to solve the problem of insufficient strength of the side part of the collapsible part. Consequently, the structure of the collapsible water tank is simpler, easier to manufacture, and lower in cost.

Further, the top cover 201 is designed to be gradually recessed downward along the direction of the edge to the center, and a water collecting pool 202 is formed on the top of the water tank 200. The bottom of the water collecting pool 202 has a through hole 205 which communicates with the inside of the water tank 200. When replenishing water to the collapsible air humidifier, water is poured from the top cover 201 of the water tank 200. After the water is collected by the water collecting pool 202, it flows into the water tank 200 through the through hole 205. During the replenishment process, the water will not overflow. The shape of the water collecting pool 202 is not limited by the shape of this embodiment, as long as the top cover 201 has a high edge and a low center, the water collecting pool 202 is formed on the top cover 201 to collect water and guide it into the water tank 200.

Further, the bottom of the water collecting pool 202 includes a plurality of through holes 205, each of the through holes 205 is distributed on a circumference with a center of the top cover 201 as a center of a circle, a top of the top cover 201 is provided with a small cover 203 at the center, and the small cover 203 includes an inverted conical cover bottom 2031 extending upward and outward gradually from the center of the top cover 201, a gap 2032 is formed between the inverted conical cover bottom 2031 and the top cover 201, the gap 2032 communicates with the through holes 205, and a projection of the small cover 203 on a top plate covers each of the through holes 205. In this way, when water is replenished from any position around the collapsible air humidifier, the water can smoothly enter the water tank 200, and the small cover 203 can prevent external debris from falling into the water tank 200 through the through hole 205 on the top of the collapsible air humidifier. In addition, from a top view, the center of the top of the water tank 200 is the small circular cover 203, the outer circumference is the circular top cover 201, and there is an annular gap 2032 between them, which can achieve a decorative effect.

Further, the small cover 203 is composed of a combination of upper and lower parts, and is a hollow structure. In this way, the weight of the top cover 201 of the water tank 200 is smaller, and the stability of the collapsible water tank 200 can be improved.

In this embodiment, the bottom cover 211 of the water tank 200 is provided with a water valve 210 and a mist inlet 209, the bottom of the containing cavity 102 is provided with an ultrasonic atomizer 103, and the water tank 200 is limited by the steps 104 in the containing cavity 102, so that an atomizing cavity 300 communicating with the water valve 210 and the mist inlet 209 is formed between the bottom cover 211 of the water tank 200 and the bottom of the containing cavity 102. The top cover 201 of the water tank 200 is provided with a mist outlet 204, a pipe 400 is connected between the mist outlet 204 and the mist inlet 209 in the water tank 200, and the pipe 400 is retractable.

In FIG. 4, the direction of water flow is indicated by a double-dotted line with an arrow, and the direction of water mist is indicated by a solid line with an arrow. During application, the water is replenished into the water tank 200 through the through hole 205 on the top cover 201, the water in the water tank 200 enters the atomizing cavity 300 from the water valve 210 at the bottom of the water tank 200, and the water in the atomizing cavity 300 enters the ultrasonic atomizer 103. Under the action, the water is converted into water mist, which is sequentially output to the environment from the mist inlet 209, the pipe 400 and the mist outlet 204, so as to achieve the purpose of humidifying the ambient air.

In order to increase the humidification effect, a fan 105 is further provided on the base 100, and the air outlet of the fan 105 is communicated with the pipe 400. After the fan 105 is turned on, the water mist in the pipe 400 is quickly blown into the environment, which speeds up the output of the water mist, and the ambient air can obtain a better humidification effect.

Further, a man-machine interface 101 is provided on the outer part of the base 100, and the man-machine interface 101 is electrically connected with the controller of the collapsible air humidifier, and can display the working status of the collapsible air humidifier. For example, the man-machine interface 101 can display the duration of continuous humidification, standby status, charging status, etc., and the user can also control the collapsible air humidifier through the man-machine interface 101.

### Second Embodiment

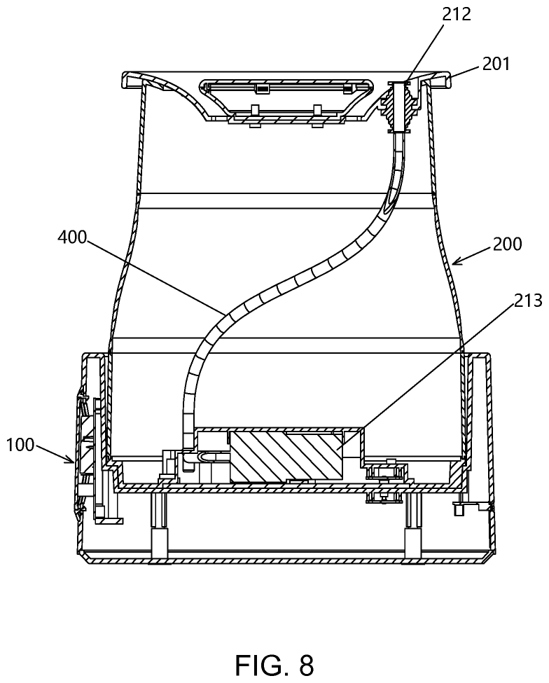

As shown in FIGS. 7 and 8, the collapsible air humidifier of the second embodiment is also a collapsible air humidifier and also includes a base 100 and a water tank 200.

The base 100 has a mouth-up cavity.

The structure of the water tank 200 is the same as that of the water tank 200 in the first embodiment, and will not be repeated here.

The difference from the first embodiment is as follows.

In the first embodiment, an ultrasonic atomizer 103 is used to convert water into water mist. The ultrasonic atomizer 103 is installed in the containing cavity 102 of the base 100, and the bottom cover 211 of the water tank 200 and the containing cavity 102 are used to form an atomization cavity 300 to atomize the water.

In the second embodiment, a jet atomizer is used to convert water into water mist. Specifically, as shown in FIG. 8, a pump 213 is provided on the bottom cover of the water tank 200, the water inlet of the pump 213 is communicated with the water tank 200, and the water outlet of the pump 213 is connected with a jet atomizer (not shown). The top cover 201 of the water tank 200 is provided with a mist outlet, a pipe 400 is connected between the mist outlet and the jet atomizer in the water tank 200, and the pipe 400 can be bent. The bottom cover of the water tank 200 is also provided with a first electrical connector (not shown), and the base 100 is provided with a second electrical connector (not shown) at a position corresponding to the first electrical connector. The first electrical connector cooperates with the second electrical connector to provide the pump 213 with current required for operation. During operation, the pump 213 is started to inhale and then pressurize the water from the water tank 200, and the pressurized water flow drives the jet atomizer to work, converting the water flow into water mist, which is sequentially output to the pipe 400 and the mist outlet to achieve the purpose of humidifying the ambient air.

Further, the mist outlet of the top cover 201 of the water tank 200 is provided with a pipe joint 212. After the pipe joint 212 is externally connected to a pipe 400, the water mist can be output to the environment far away from the collapsible air humidifier body, which is more convenient to use.

The present disclosure has been described in detail above through specific embodiments. These detailed descriptions are only intended to help those skilled in the art to understand the content of the present disclosure, and should not be construed as limiting the protection scope of the present disclosure. Various modifications, equivalent transformations, etc. performed by those skilled in the art on the above solutions under the concept of the present disclosure shall be included in the protection scope of the present disclosure.

What is claimed is:

1. A collapsible air humidifier, comprising:
a base (100) including a containing cavity (102) having an upper open; and
a water tank (200) that is collapsible, having a bottom cover (211), a lower section (208), a middle section (207), an upper section (206) and a top cover (201), wherein the lower section (208) is mounted on the containing cavity (102), the middle section (207) and the upper section (206) are located above the containing cavity (102), and, the upper section (206) and the middle section (207) are stored within the middle section (208) when the water tank (200) is in a collapsed state; and
wherein the lower section (208) and the upper section (206) are rigid pieces, the middle section (207) is a flexible piece, an upper end of the middle section (207) is connected to and sealed with a lower end of the upper section (206), and a lower end of the middle section (207) is connected to and sealed with an upper end of the lower section (208).

2. The collapsible air humidifier according to claim 1, wherein each of a connection between the middle section (207) and the upper section (206) and a connection between the middle section (207) and the lower section (208) is formed by a bonding process, a soldering process or a welding process.

3. The collapsible air humidifier according to claim 1, wherein an edge of the top cover (201) is higher than a center of the top cover (201), so that a water collecting pool (202) is formed at a top of the water tank (200), and a bottom of the water collecting pool (202) is provided with at least one through hole (205) that communicates with an inside of the water tank (200).

4. The collapsible air humidifier according to claim 3, wherein multiple ones of the through holes (205) are provided, each of the through holes (205) is distributed on a circumference with a center of the top cover (201) as a center of a circle, a top of the top cover (201) is provided with a small cover (203) at the center, and the small cover (203) includes an inverted conical cover bottom (2031) extending upward and outward gradually from the center of the top cover (201), a gap (2032) is formed between the inverted conical cover bottom (2031) and the top cover (201), the gap (2032) communicates with each of the through holes (205), and a projection of the small cover (203) on a top plate covers each of the through holes (205).

5. The collapsible air humidifier according to claim 4, wherein the small cover (203) is a hollow structure.

6. The collapsible air humidifier according to claim 1, wherein the bottom cover (211) of the water tank (200) is provided with a pump (213) and a first electrical connector, a water inlet of the pump (213) is communicated with the water tank (200), a water outlet of the pump (213) is connected with a jet atomizer, the top cover (201) of the water tank (200) is provided with a mist outlet (204), a pipe (400) is connected between the mist outlet (204) and the jet atomizer in the water tank (200), the pipe (400) is retractable or bendable, and the base (100) is provided with a second electrical connector at a position corresponding to a first electrical connector.

7. The collapsible air humidifier according to claim 1, wherein the bottom cover (211) of the water tank (200) is provided with a water valve (210) and a mist inlet (209), a bottom of the containing cavity (102) is provided with an ultrasonic atomizer (103), an atomizing cavity (300) communicating with the water valve (210) and the mist inlet (209) is formed between the bottom cover (211) of the water tank (200) and the bottom of the containing cavity (102), the top cover (201) of the water tank (200) is provided with a mist outlet (204), a pipe (400) is connected between the mist outlet (204) and the mist inlet (209) in the water tank (200), and the pipe (400) is retractable or bendable.

8. The collapsible air humidifier according to claim 7, wherein the base (100) is further provided with a fan (105), and an air outlet of the fan (105) communicates with the pipe (400).

9. The collapsible air humidifier according to claim 1, wherein the top cover (201) of the water tank (200) is provided with a pipe joint (212), a pipe (400) is arranged in the water tank (200), one end of the pipe (400) is connected to the pipe joint (212), another end of the pipe (400) is connected to a mist outlet end of a jet atomizer or to a atomizing cavity (300), and the pipe (400) is retractable or bendable.

10. The collapsible air humidifier according to claim 1, wherein a man-machine interface (101) is provided on an outer part of the base (100), and the man-machine interface (101) is electrically connected to a controller of the collapsible air humidifier.

11. The collapsible air humidifier according to claim 1, wherein the bottom cover (211) is integrally formed with the lower section (208).
